(19) United States
(12) Patent Application Publication
(10) Pub. No.: US 2026/0299455 A1
(43) Pub. Date: Oct. 1, 2026

(54) CHARGING DEVICE AND IMAGE FORMING APPARATUS

(71) Applicant: FUJIFILM Business Innovation Corp., Tokyo (JP)

(72) Inventors: Masaya FUKUSHIMA, Kanagawa (JP); Yuki Nagamori, Kanagawa (JP); Go Miura, Kanagawa (JP); Taro Mitsui, Kanagawa (JP); Yudai Kamatani, Kanagawa (JP); Ibuki Masuda, Kanagawa (JP); Takayuki Maeda, Kanagawa (JP)

(73) Assignee: FUJIFILM Business Innovation Corp., Tokyo (JP)

(21) Appl. No.: 19/315,889

(22) Filed: Sep. 2, 2025

(30) Foreign Application Priority Data
Mar. 26, 2025 (JP) 2025-052124

(51) Int. Cl. G03G 15/02

(52) U.S. Cl. CPC G03G 15/0266; G03G 15/0291; G03G 2215/027

(57) ABSTRACT

A charging device includes a discharge electrode and a control electrode that is disposed between the discharge electrode and a member to be charged, in which the control electrode is held in a state of being curved along a surface shape of the member to be charged, is pushed to a side away from the member to be charged at a plurality of positions along a lateral direction of the control electrode, and further protrudes toward the side away from the member to be charged on a middle side than on end sides in the lateral direction among the plurality of positions where the control electrode is pushed.

### CROSS-REFERENCE TO RELATED APPLICATIONS

This application is based on and claims priority under 35 USC 119 from Japanese Patent Application No. 2025-052124 filed Mar. 26, 2025.

### BACKGROUND

### (i) Technical Field

The present invention relates to a charging device and an image forming apparatus.

### (ii) Related Art

Techniques disclosed in JP2018-159793A ([0035] to [0087], FIGS. 2 to 6) and JP2021-056456A ([0054] to [0099], FIGS. 4 to 7) to be described below are publicly known in the related art in regard to a charger that charges the surface of an image holder in an electrophotographic image forming apparatus in the related art.

JP2018-159793A ([0035] to [0087], FIGS. 2 to 6) discloses a technique of curving an electrode member (40) of a charging unit (60) with two contact members (53, 54) provided at end portions of a photoreceptor (30) in an axial direction. The first contact member (53) is disposed on an outer side in the axial direction and is formed in a quadrangular plate shape. The second contact member (54) is disposed on an inner side in the axial direction and is formed in a triangular plate shape. In JP2018-159793A ([0035] to [0087], FIGS. 2 to 6), two corners of the quadrangular plate-shaped first contact member (53) are in contact with the electrode member (40) on the outer side in the axial direction, and a pointed corner of the triangular plate-shaped second contact member (54) is in contact with the electrode member (40) on the inner side in the axial direction, so that the electrode member (40) is deformed into a curved shape.

JP2021-056456A ([0054] to [0099], FIGS. 4 to 7) discloses a configuration in which two grid electrodes (53) of a charging device (214) are disposed with a partition plate (66) interposed therebetween. The grid electrode (53) provided on the upstream side of the partition plate (66) in a rotation direction of a photoreceptor drum (213) is disposed to be inclined in a direction away from the photoreceptor drum (213) toward the downstream side. The grid electrode (53) provided on the downstream side of the partition plate (66) is disposed to be inclined in a direction in which the grid electrode (53) approaches the photoreceptor drum (213) toward the downstream side.

### SUMMARY

Aspects of non-limiting embodiments of the present disclosure relate to a charging device and an image forming apparatus that suppress a variation in the curvature of a control electrode in a longitudinal direction as compared to a case where end portions of the control electrode in the longitudinal direction are made to abut against abutting portions having a shape corresponding to the curvature of a member to be charged to curve the control electrode according to the curvature of the member to be charged.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

In order to achieve the technical object, according to an aspect of the present disclosure, there is provided a charging device including a discharge electrode and a control electrode that is disposed between the discharge electrode and a member to be charged, in which the control electrode is held in a state of being curved along a surface shape of the member to be charged, is pushed to a side away from the member to be charged at a plurality of positions along a lateral direction of the control electrode, and further protrudes toward the side away from the member to be charged on a middle side than on end sides in the lateral direction among the plurality of positions where the control electrode is pushed.

### BRIEF DESCRIPTION OF THE DRAWINGS

Exemplary embodiment(s) of the present invention will be described in detail based on the following figures, wherein:

FIG. 1 is an overall view of an image forming apparatus of Example 1 of the present invention;

FIG. 2 is a diagram illustrating a visible image forming device that includes an image holder unit and a developing unit;

FIG. 3 is a perspective view of a charger of Example 1 of the present invention;

FIG. 4 is a cross-sectional view of a major part of the charger of Example 1 of the present invention;

FIG. 5 is a diagram illustrating a grid electrode of Example 1;

FIG. 6 is a diagram illustrating a major part of the charger in a state where the grid electrode is stretched;

FIG. 7 is a diagram illustrating an abutting section of Example 1;

FIGS. 8A and 8B are diagrams illustrating a pulling section of Example 1, in which FIG. 8A is a perspective view and FIG. 8B is a diagram viewed in a direction of an arrow VIIIB in FIG. 8A;

FIG. 9 is an enlarged view illustrating a curving section of Example 1;

FIG. 10 is a diagram illustrating an experimental example in a case where the diameter of a drum is small;

FIG. 11 is a diagram illustrating an experimental example in a case where the diameter of the drum is large; and

FIG. 12 is a diagram illustrating an abutting section of Example 2, and is a diagram corresponding to FIG. 9 of Example 1.

### DETAILED DESCRIPTION

Next, specific examples (hereinafter, referred to as Examples) of an exemplary embodiment of the present invention will be described with reference to the drawings. However, the present invention is not limited to the following examples.

In order to facilitate the understanding of the following description, in the drawings, a front-rear direction will be defined as an X-axis direction, a right-left direction will be defined as a Y-axis direction, and a vertical direction will be defined as a Z-axis direction. Directions or sides indicated by arrows X, −X, Y, −Y, Z, and −Z will be defined as a forward direction, a rearward direction, a rightward direction, a leftward direction, an upward direction, and a downward direction, or a front side, a rear side, a right side, a left side, an upper side, and a lower side, respectively.

Further, in the drawings, a symbol “○” with a symbol “⋅” therein means an arrow from the back of the plane of the sheet to the front thereof and a symbol “○” with a symbol “x” therein means an arrow from the front of the plane of the sheet to the back thereof.

In the following description using the drawings, members other than members required for description will be appropriately omitted to facilitate understanding.

### Example 1

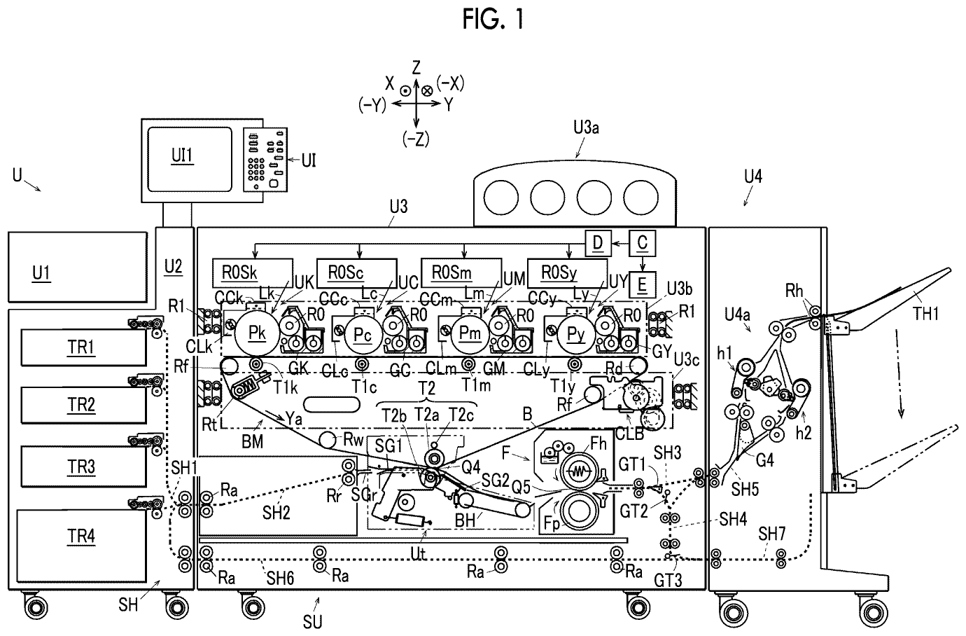

FIG. 1 is an overall view of an image forming apparatus of Example 1 of the present invention.

In FIG. 1, the image forming apparatus U includes a user interface UI as an example of an operation section, an image input device U1 as an example of an image reading section, a sheet feed device U2 as an example of a medium feed section, an image recording device U3 as an example of a body of the image forming apparatus, and a sheet processing device U4 as an example of a post-processing section.

The user interface UI includes input keys, such as a copy start key and a numeric keypad, as an example of an input section, and a display UI1.

The image input device U1 is formed of an image scanner or the like that is an example of an image reading device. In FIG. 1, the image input device U1 reads an original document (not shown) to convert the original document into image information, and inputs the image information to the image recording device U3.

The sheet feed device U2 includes sheet feed trays TR1, TR2, TR3, and TR4 as an example of a plurality of medium storage sections, a sheet feed passage SH1 through which recording sheets S as an example of mediums stored in each of the sheet feed trays TR1 to TR4 are transported, and the like.

In FIG. 1, the image recording device U3 includes an image recording unit that records an image on the recording sheet S transported from the sheet feed device U2, a toner dispenser unit U3a, a sheet transport passage SH2, a sheet discharge passage SH3, a sheet inversion passage SH4, a sheet circulation passage SH6, and the like. The image recording unit will be described later.

Further, the image recording device U3 includes a controller C as an example of a control section, a laser drive circuit D as an example of a drive circuit of a latent image writing device that is controlled by the controller C, a power source circuit E that is controlled by the controller C, and the like. The laser drive circuit D outputs laser drive signals, which correspond to image information for Y (yellow), M (magenta), C (cyan), and K (black) input from the image input device U1, to respective color latent image forming devices ROSy, ROSm, ROSc, and ROSk at preset times.

A pull-out member U3b for an image forming unit is supported below the latent image forming devices ROSy to ROSk, which are an example of a latent image forming section, by a pair of right and left guide members R1 and R1 to be movable between a pull-out position where the pull-out member U3b is pulled out to the front of the image recording device U3 and a mounting position where the pull-out member U3b is mounted inside the image recording device U3.

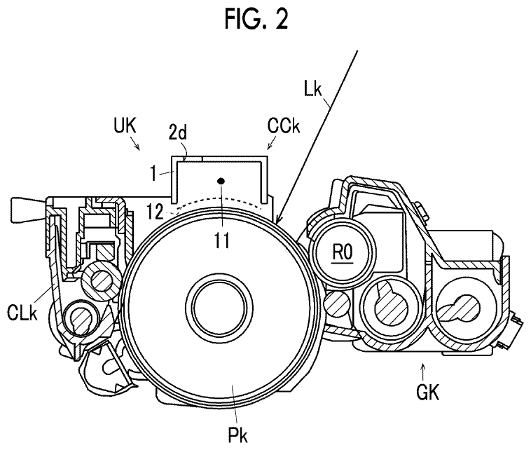

FIG. 2 is a diagram illustrating a visible image forming device that includes an image holder unit and a developing unit.

In FIGS. 1 and 2, an image holder unit UK for black includes a photoreceptor drum Pk as an example of an image holding section, a charger CCk that is an example of a charging device and an example of a charging section, and a photoreceptor cleaner CLk as an example of a cleaning section for the image holding section. In Example 1, the charger CCk is formed of a charging unit that can be attached to and detached from the image recording device U3. Further, image holder units UY, UM, and UC for the other colors Y, M, and C also include photoreceptor drums Py, Pm, and Pc, chargers CCy, CCm, and CCc, and photoreceptor cleaners CLy, CLm, and CLc. Furthermore, in Example 1, the photoreceptor drum Pk for black (K) of which the frequency of use is high and the surface is to be more worn is formed to have a larger diameter than the photoreceptor drums Py, Pm, and Pc for the other colors. Accordingly, the photoreceptor drum Pk copes with high-speed rotation and achieves a long service life.

The image holder units UY, UM, UC, and UK and developing units GY, GM, GC, and GK including developing rollers R0 constitute toner image forming members UY+GY, UM+GM, UC+GC, and UK+GK. The image holder units UY, UM, UC, and UK, and the developing units GY, GM, GC, and GK are attachably and detachably mounted on the pull-out member U3b for an image forming unit.

In FIG. 1, the photoreceptor drums Py to Pk are charged by the chargers CCy to CCk, respectively, and then electrostatic latent images are formed on the surfaces of the photoreceptor drums Py to Pk by laser beams Ly, Lm, Lc, and Lk as an example of latent image writing light output from the latent image forming devices ROSy to ROSk. The electrostatic latent images formed on the surfaces of the photoreceptor drums Py to Pk are developed into yellow (Y), magenta (M), cyan (C), and black (K) toner images by the developing units GY to GK as an example of a developing section.

The toner images on the surfaces of the photoreceptor drums Py to Pk are sequentially superimposed and transferred onto an intermediate transfer belt B, which is an example of an image holding section and an example of an intermediate transfer body, by primary transfer rollers T1y, T1m, T1c, and T1k as an example of a primary transfer section, so that a multicolor image, that is, a so-called color image is formed on the intermediate transfer belt B. The color image formed on the intermediate transfer belt B is transported to a secondary transfer region Q4.

Further, in the case of only black image data, only the photoreceptor drum Pk and the developing unit GK for black (K) are used and only a black toner image is formed.

After primary transfer, residual toner on the surfaces of the photoreceptor drums Py to Pk is cleaned off by the photoreceptor cleaners CLy to CLk.

A pull-out member U3c for an intermediate transfer body is supported below the pull-out member U3b for an image forming unit to be movable between a pull-out position where the pull-out member U3c is pulled out to the front of the image recording device U3 and a mounting position where the pull-out member U3c is mounted inside the image recording device U3. A belt module BM as an example of an intermediate transfer section is supported at the pull-out member U3c for an intermediate transfer body to be liftable and lowerable between a raised position where the belt module BM is in contact with lower surfaces of the photoreceptor drums Py to Pk and a lowered position where the belt module BM is separated downward from the lower surfaces.

The belt module BM includes the intermediate transfer belt B, a belt drive roller Rd as an example of a drive section, a tension roller Rt as an example of a tensioning section, a walking roller Rw as an example of a meandering prevention section, a plurality of idler rollers Rf as an example of a driven section, a backup roller T2a as an example of a facing section for the secondary transfer region Q4, and primary transfer rollers T1y to T1k. The intermediate transfer belt B is supported by the belt support rollers Rd, Rt, Rw, Rf, and T2a to be rotatable and movable in the direction of an arrow Ya.

A secondary transfer unit Ut is disposed below the backup roller T2a. The secondary transfer unit Ut includes a secondary transfer roller T2b as an example of a secondary transfer member. The secondary transfer roller T2b is disposed to be capable of being separated from and in contact with the backup roller T2a with the intermediate transfer belt B interposed therebetween, and a region where the secondary transfer roller T2b is in contact with the intermediate transfer belt B form the secondary transfer region Q4. Further, a contact roller T2c as an example of a voltage application section is in contact with the backup roller T2a, and the respective rollers T2a to T2c constitute a secondary transfer module T2 as an example of a secondary transfer section.

A secondary transfer voltage having a polarity identical to the charging polarity of the toner is applied to the contact roller T2c from the power source circuit E, which is controlled by the controller C, at a preset time.

The sheet transport passage SH2 is disposed below the belt module BM. The recording sheet S fed from the sheet feed passage SH1 of the sheet feed device U2 is transported to the sheet transport passage SH2, and is transported to the secondary transfer region Q4 through medium guide members SGr and SG1 before transfer by a registration roller Rr, which is an example of a section for adjusting a paper feeding time, in time with the transport of the toner images to the secondary transfer region Q4.

The toner images formed on the intermediate transfer belt B are transferred onto the recording sheet S by the secondary transfer module T2 when passing through the secondary transfer region Q4. Meanwhile, in the case of a full color image, the toner images superimposed and primarily transferred onto the surface of the intermediate transfer belt B are collectively secondarily transferred onto the recording sheet S.

The intermediate transfer belt B from which the toner images have been secondarily transferred is cleaned by a belt cleaner CLB as an example of a cleaning section for an intermediate transfer body.

The primary transfer rollers T1y to T1k, the intermediate transfer belt B, the secondary transfer module T2, the belt cleaner CLB, and the like constitute a transfer device (an example of a transfer section) T1+B+T2+CLB that transfers the images formed on the surfaces of the photoreceptor drums Py to Pk onto the recording sheet S.

The recording sheet S onto which the toner images are secondarily transferred is transported to a fixing device F through a medium guide member SG2 after transfer and a sheet transport belt BH as an example of a medium transport member before fixing. The fixing device F as an example of a fixing section includes a heating roller Fh as an example of a heating fixing section and a pressure roller Fp as an example of a pressure fixing section, and a region where the heating roller Fh and the pressure roller Fp are in contact with each other forms a fixing region Q5.

The toner images transferred onto the recording sheet S are heated and fixed by the fixing device F when passing through the fixing region Q5.

The toner image forming members UY+GY, UM+GM, UC+GC, and UK+GK and the transfer device T1+B+T2+CLB, the fixing device F, and the like constitute the image recording unit of Example 1 that records an image on the recording sheet S.

A first gate GT1 as an example of a section for switching a transport passage is provided on a downstream side of the fixing device F. The first gate GT1 selectively switches the recording sheet S, which is transported through the sheet transport passage SH2 and to which the toner images have been heated and fixed in the fixing region Q5, to either the sheet discharge passage SH3 or the sheet inversion passage SH4 of the image recording device U3. The recording sheet S transported to the sheet discharge passage SH3 is transported to a sheet transport passage SH5 of the sheet processing device U4.

A curl correction device U4a as an example of a curvature correction section is disposed in the middle of the sheet transport passage SH5, and a second gate G4 as an example of a section for switching a transport passage is disposed in the sheet transport passage SH5. The second gate G4 transports the recording sheet S, which is transported from the sheet discharge passage SH3 of the image recording device U3, toward either a first curl correction member h1 or a second curl correction member h2 depending on a direction of curvature, that is, so-called curl. The curl of the recording sheet S transported to the first curl correction member h1 or the second curl correction member h2 is corrected while the recording sheet S passes through the first curl correction member h1 or the second curl correction member h2. The recording sheet S of which the curl is corrected is discharged from a discharge roller Rh as an example of a discharge section to a discharge tray TH1 as an example of a discharge unit of the sheet processing device U4 in a state where a surface of the sheet to which the images are fixed faces upward, that is, in a so-called face-up state.

The recording sheet S, which is transported toward the sheet inversion passage SH4 of the image recording device U3 by the first gate GT1, passes through a transport direction-restricting section formed of an elastic thin film-like member, that is, a so-called miller gate GT2 while pushing the miller gate GT2, and is transported to the sheet inversion passage SH4 of the image recording device U3.

The sheet circulation passage SH6 and a sheet inversion passage SH7 are connected to a downstream end of the sheet inversion passage SH4 of the image recording device U3, and a miller gate GT3 is also disposed at a connection portion where the sheet circulation passage SH6 and the sheet inversion passage SH7 are connected to the sheet inversion passage SH4. The sheet, which is transported to the sheet inversion passage SH4 through the first gate GT1, passes through the miller gate GT3 and is transported toward the sheet inversion passage SH7 of the sheet processing device U4. In a case where two-sided printing is performed, the recording sheet S that has been transported through the sheet inversion passage SH4 passes through the miller gate GT3 and is transported to the sheet inversion passage SH7 and is then transported in a reverse direction, that is, so-called switched back. In this case, the recording sheet S of which the transport direction is restricted by the miller gate GT3 and which has been switched back is transported toward the sheet circulation passage SH6. The recording sheet S transported to the sheet circulation passage SH6 is transported to the secondary transfer region Q4 through the sheet feed passage SH1 again.

On the other hand, in a case where the recording sheet S transported through the sheet inversion passage SH4 is switched back before a rear end of the recording sheet S passes through the miller gate GT3 after passing through the miller gate GT2, the transport direction of the recording sheet S is restricted by the miller gate GT2 and the recording sheet S is transported to the sheet transport passage SH5 in a state where the recording sheet S is inverted. After the curl of the inverted recording sheet S is corrected by the curl correction device U4a, the inverted recording sheet S can be discharged to the discharge tray TH1 of the sheet processing device U4 in a state where the surface of the recording sheet S to which the images are fixed faces downward, that is, in a so-called face-down state.

The elements denoted by the reference numerals SH1 to SH7 constitute a sheet transport passage SH. Further, the elements denoted by the reference numerals SH, Ra, Rr, Rh, SGr, SG1, SG2, BH, and GT1 to GT3 constitute a sheet transport device SU.

### Description of Charger

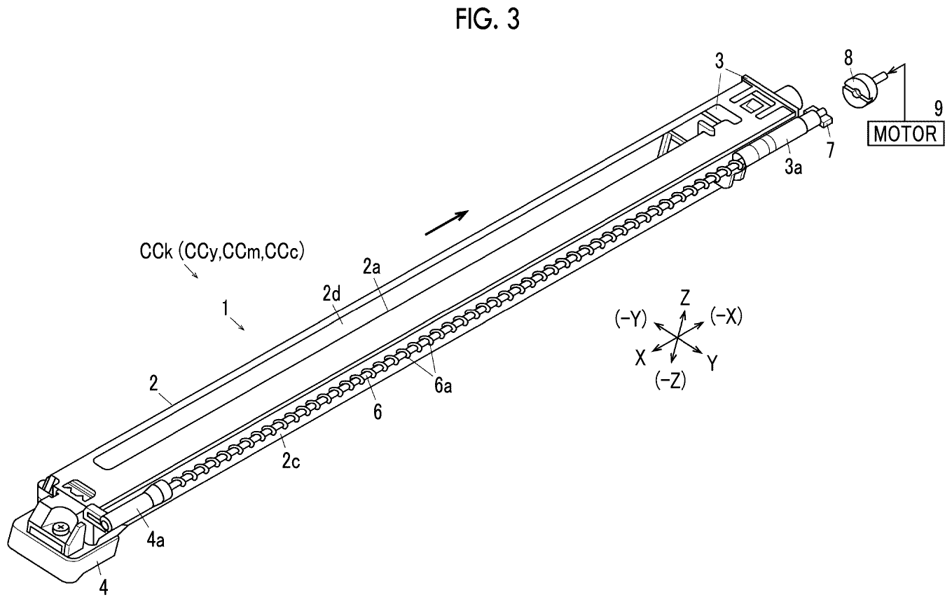

FIG. 3 is a perspective view of the charger of Example 1 of the present invention.

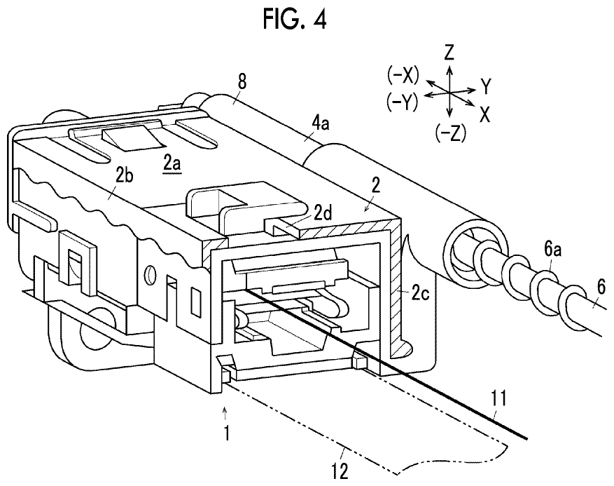

FIG. 4 is a cross-sectional view of a major part of the charger of Example 1 of the present invention.

In FIG. 4, a part of a shield electrode is not shown to facilitate the understanding of the invention.

Next, the charger of Example 1 will be described. However, since the chargers CCy to CCk for the respective colors of Y, M, C, and K have an identical configuration, the charger CCk for black (K) will be described in detail and the detailed description of the chargers CCy to CCc of the other colors will be omitted.

In FIGS. 2, 3, and 4, the charger CCk of Example 1 includes a charger body 1 that extends in the front-rear direction. The charger body 1 includes a shield electrode 2. The shield electrode 2 is made of a conductive metal material. The shield electrode 2 includes a plate-like upper wall portion 2a that extends in the front-rear direction, and plate-like left and right wall portions 2b and 2c that extend downward from both left and right sides of the upper wall portion 2a. An opening 2d extending in the front-rear direction is formed at a left portion of the upper wall portion 2a.

A rear end block 3 as an example of one end member is supported at a rear end of the shield electrode 2, and a front end block 4 as an example of the other end member is supported at a front end of the shield electrode 2. Tubular shaft receiving portions 3a and 4a extending in the front-rear direction are formed at upper right portions of the front and rear blocks 3 and 4 as an example of a support body for a movable cleaning member.

A shaft 6, which extends in the front-rear direction, as an example of a rotating member is rotatably supported by the shaft receiving portions 3a and 4a. A thread 6a is formed on an outer peripheral surface of the shaft 6. A rear end portion of the shaft 6 penetrates the rear shaft receiving portion 3a and extends rearward, and a driven coupling 7 as an example of a transmission target member is supported at the rear end of the shaft 6. A drive coupling 8 as an example of a transmission member is disposed in the image recording device U3. In a case where the charger CCk is mounted on the image recording device U3, the driven coupling 7 is supported in a state where the driven coupling 7 meshes with the drive coupling 8. The drive coupling 8 is adapted such that drive from a motor 9 for an electrode cleaner as an example of a drive source for an electrode cleaning member can be transmitted to the drive coupling 8. A motor that can be driven in a normal direction and a reverse direction is used as the motor 9 for an electrode cleaner of Example 1.

An aspect in which the shaft 6 is disposed on the right side of the charger CCk has been exemplified in Example 1, but the present invention is not limited thereto. An aspect in which the shaft 6 is disposed on the upper portion or the left side of the charger CCk may be adopted.

In FIGS. 2 to 4, a wire electrode 11, which is an example of a discharge electrode and an example of a first electrode, is disposed in the charger body 1. The wire electrode 11 of Example 1 is formed of wire rods extending in the front-rear direction. Both front and rear ends of the wire electrode 11 are supported by the respective blocks 3 and 4. A grid electrode 12, which is an example of a control electrode and an example of a second electrode, is supported at a position of a lower opening of the shield electrode 2 between the wire electrode 11 and the photoreceptor drum Pk, that is, in a charging region that is a region facing the photoreceptor drum Pk as an example of a member to be charged.

In a case where a voltage is applied to the grid electrode 12 to control electric charges in a state where power is supplied to the wire electrode 11, discharge occurs due to a potential difference between the wire electrode 11 and the grid electrode 12. The surface of the photoreceptor drum Pk is charged by released electric charges.

### Description of Grid Electrode

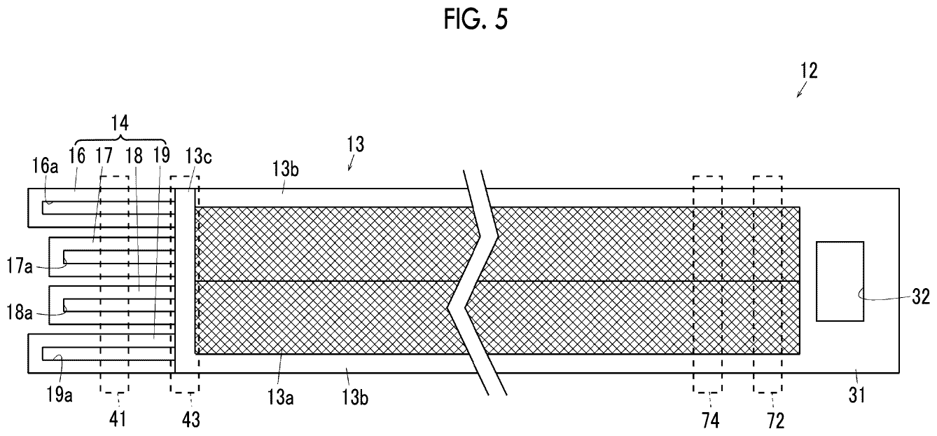

FIG. 5 is a diagram illustrating the grid electrode of Example 1.

In FIG. 5, the grid electrode 12 of Example 1 includes a net-like portion 13 extending in a longitudinal direction (an axial direction of the photoreceptor drum) as an example of a net portion. The net-like portion 13 is formed in the shape of a net in which a plurality of first openings 13a are formed. Edge portions 13b as an example of beam portions are formed at both end portions of the net-like portion 13 in a width direction (a rotation direction of the photoreceptor drum, a lateral direction).

A hook portion 14 as an example of a section to be pulled is disposed at a front end portion that is an example of one end portion of the net-like portion 13 in the longitudinal direction. The hook portion 14 of Example 1 includes a first hook portion 16, a second hook portion 17, a third hook portion 18, and a fourth hook portion 19. The first to fourth hook portions 16 to 19 are arranged at intervals from one end of the net-like portion 13 in the lateral direction to the other end thereof.

Each of the first to fourth hook portions 16 to 19 is formed in the shape of a strip extending in the longitudinal direction. Openings 16a to 19a are formed in the first to fourth hook portions 16 to 19, respectively. Therefore, the first to fourth hook portions 16 to 19 of Example 1 are formed in the shape of a rectangular frame extending in the longitudinal direction.

In Example 1, in regard to the lengths of the first to fourth hook portions 16 to 19 in the longitudinal direction, the first and fourth hook portions 16 and 19, which are disposed at both ends of the net-like portion 13 in the lateral direction, are formed to be longer than the second and third hook portions 17 and 18, which are disposed on the inner side of the net-like portion 13 in the lateral direction. It is preferable that the first and fourth hook portions 16 and 19 are formed to be longer than the second and third hook portions 17 and 18, but the present invention is not limited thereto. All the hook portions 16 to 19 can also be formed to have an identical length.

A rear frame portion 31 is provided at a rear end portion that is an example of the other end portion of the net-like portion 13 in the longitudinal direction. A positioning opening 32 as an example of a portion to be positioned is formed at the rear frame portion 31.

### Description of Tension Applying Section

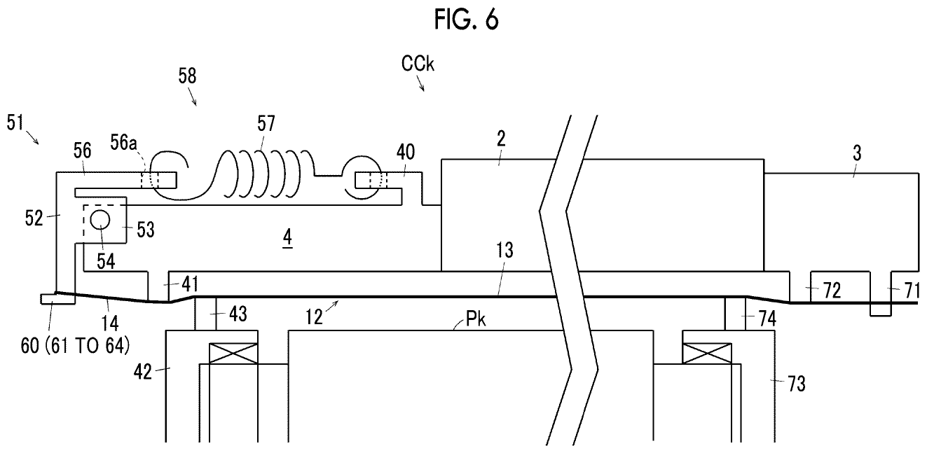

FIG. 6 is a diagram illustrating a major part of the charger in a state where the grid electrode is stretched.

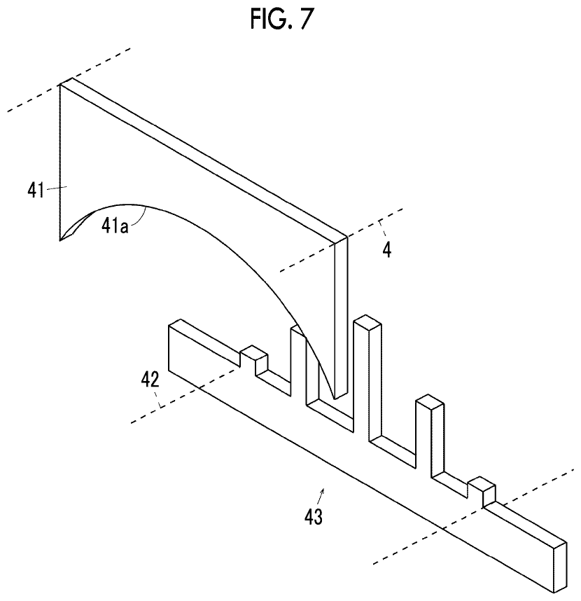

FIG. 7 is a diagram illustrating an abutting section of Example 1.

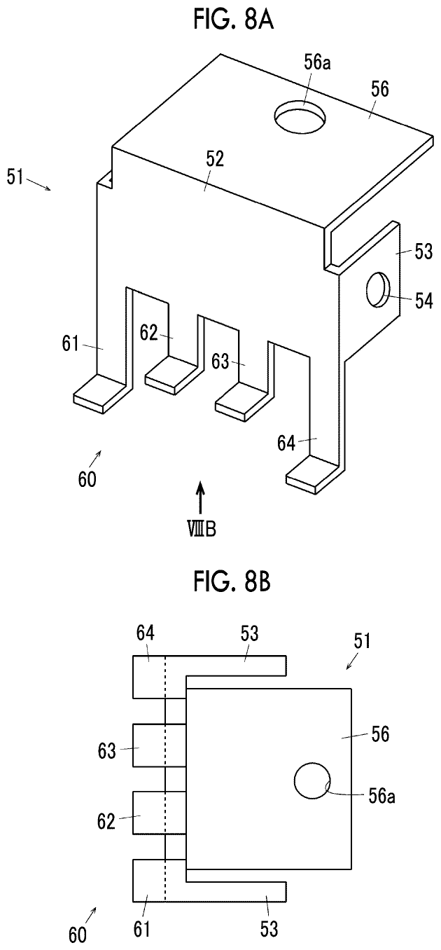

FIGS. 8A and 8B are diagrams illustrating a pulling section of Example 1, in which FIG. 8A is a perspective view and FIG. 8B is a diagram viewed in a direction of an arrow VIIIB in FIG. 8A.

In order to illustrate a configuration for stretching the grid electrode, other members and portions that are not related to stretching are not shown in FIGS. 6 to 8B.

In FIG. 6, a spring mounting portion 40 as an example of a mounting target portion is formed on a side of the front end block 4 farther from an upper surface of the front end portion, that is, farther from the photoreceptor drum Pk.

In FIGS. 6 and 7, a front abutting portion 41 as an example of an abutting section is formed on a lower surface of a front end portion of the front end block 4 as an example of a frame body of the charging device, that is, on a side of the front end block 4 close to the photoreceptor drum Pk. The front abutting portion 41 is formed in a shape protruding downward (toward the photoreceptor drum Pk). In FIG. 7, a lower surface 41a of the front abutting portion 41 facing the photoreceptor drum Pk is formed of a curved surface that is curved downward as extending outward in the width direction (lateral direction) of the charger CCk. The lower surface 41a is set to a curved surface corresponding to the curvature of the surface of the cylindrical photoreceptor drum Pk.

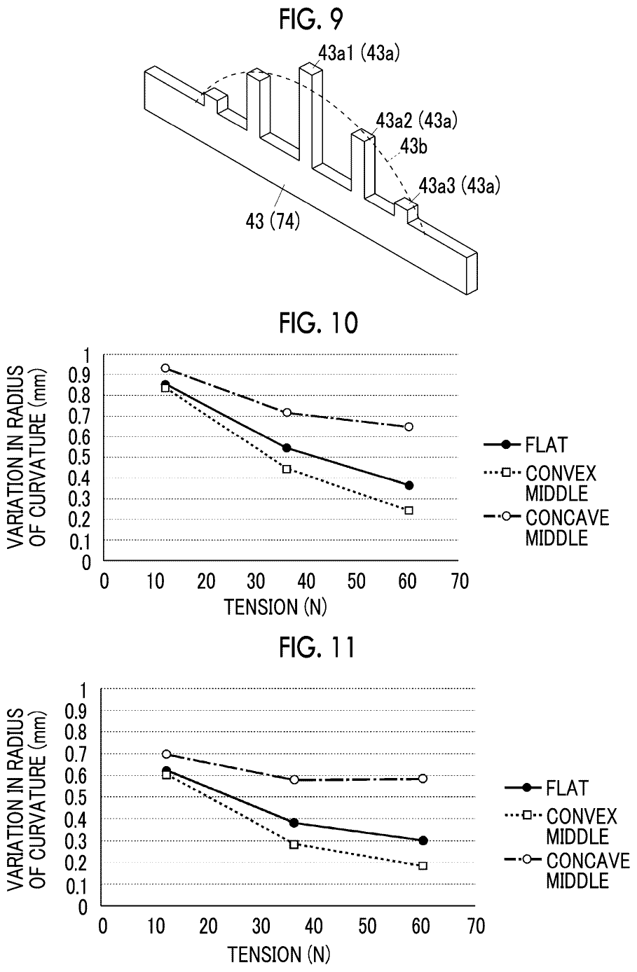

FIG. 9 is an enlarged view illustrating a curving section of Example 1.

A second front abutting portion 43, which serves as an example of a curving section and an example of a second abutting section, is formed on a front bearing portion 42 of the photoreceptor drum Pk at a position on the rear side of the front abutting portion 41. A plurality of protruding portions 43a as an example of contact portions are formed on the second front abutting portion 43. The protruding portions 43a protrude upward (toward a side away from the photoreceptor drum Pk). Therefore, the second front abutting portion 43 is formed in a so-called comb-tooth shape.

The protruding portions 43a of Example 1 are formed such that the lengths of the protruding portions 43a decrease toward the outside in the width direction (lateral direction) of the charger CCk based on the curvature of the surface of the photoreceptor drum Pk. In particular, in Example 1, a protruding portion 43a1 provided on a middle side in the lateral direction of the grid electrode 12 is formed to be longer than a protruding portion 43a3 provided on an end side in the lateral direction with respect to a curved line 43b corresponding to a surface shape of the photoreceptor drum Pk. For example, the protruding portion 43a3 provided on the end side coincides with a position corresponding to the curved line 43b, and the protruding portion 43a1 provided on the middle side protrudes upward (toward the side away from the photoreceptor drum Pk) from the curved line 43b. An intermediate protruding portion 43a2 is formed such that the amount of protrusion of the intermediate protruding portion 43a2 from the curved line 43b is smaller than the amount of protrusion of the protruding portion 43a1 provided on the middle side from the curved line 43b and is larger than the amount of protrusion of the protruding portion 43a3 provided on the end side from the curved line 43b.

The front abutting portion 41 and the second front abutting portion 43 are set such that upper ends of the protruding portions 43a of the second front abutting portion 43 are positioned above the lower surface 41a of the front abutting portion 41 in a state where the charger CCk is mounted on the image recording device U3.

In Example 1, the front abutting portion 41 is in contact with the hook portion 14 of the grid electrode 12 from above as shown in FIGS. 5 and 6. Further, the second front abutting portion 43 is in contact with a front frame portion 13c of the net-like portion 13 of the grid electrode 12 from below. In a case where the front abutting portion 41 is in contact with the front frame portion 13c instead of the net-like portion 13 that is likely to be damaged, the grid electrode 12 is less likely to be damaged and a force is easily transmitted.

Accordingly, the grid electrode 12 of Example 1 is held in a state of being curved along the surface shape of the photoreceptor drum Pk, is pushed to the side away from the photoreceptor drum Pk at a plurality of positions along the lateral direction of the grid electrode 12, and further protrudes toward the side away from the photoreceptor drum Pk on the middle side than on the end sides in the lateral direction among the plurality of positions where the grid electrode 12 is pushed.

Further, in Example 1, the grid electrode 12 is held in a state of being curved along the surface shape of the photoreceptor drum Pk, at least one portion (between the protruding portions 43a) where the grid electrode 12 is not pushed to the side away from the photoreceptor drum Pk is present along the lateral direction of the grid electrode 12, and the grid electrode 12 further protrudes toward the side away from the photoreceptor drum Pk on the middle side than on the end sides in the lateral direction among the plurality of positions where the grid electrode 12 is pushed.

Accordingly, in Example 1, the grid electrode 12 is held in a state of being curved along the surface shape of the photoreceptor drum Pk and is pushed to the side away from the photoreceptor drum Pk at a plurality of positions along the lateral direction of the grid electrode 12, and a pushing force is stronger on the middle side than on the end sides in the lateral direction among the plurality of positions where the grid electrode 12 is pushed.

In FIG. 6, a pulling member 51 as an example of a pulling section is supported by a front end portion of the front end block 4.

In FIGS. 6, 8A, and 8B, the pulling member 51 includes a body portion 52 extending in the vertical direction. The body portion 52 of Example 1 is formed in the shape of a plate. Rotationally supported portions 53 extending rearward are formed on both left and right sides of the body portion 52. The rotationally supported portions 53 are rotatably supported by the front end block 4 via through-hole portions 54. Therefore, the pulling member 51 is rotatable about the through-hole portions 54.

A mounting target portion 56 extending rearward is formed at an upper end portion of the body portion 52. A spring mounting hole 56a is formed in the mounting target portion 56. A spring 57 as an example of a tension generating section is mounted between the mounting target portion 56 and the spring mounting portion 40.

A hook claw 60 as an example of a pulling portion is formed at a lower portion of the body portion 52. The hook claw 60 includes a first claw portion 61, a second claw portion 62, a third claw portion 63, and a fourth claw portion 64 corresponding to the first to fourth hook portions 16 to 19. Therefore, the first to fourth claw portions 61 to 64 can support the first to fourth hook portions 16 to 19 in a state where the first to fourth claw portions 61 to 64 penetrate the openings 16a to 19a of the first to fourth hook portions 16 to 19 and are caught by the first to fourth hook portions 16 to 19.

In Example 1, in regard to the lengths of the first to fourth claw portions 61 to 64 in the vertical direction, that is, the lengths of the first to fourth claw portions 61 to 64 extending toward the photoreceptor drum Pk, the lengths of the first and fourth claw portions 61 and 64 provided on both sides in the lateral direction are longer than the lengths of the second and third claw portions 62 and 63 on the inside in the lateral direction. That is, the lengths of the first to fourth claw portions 61 to 64 are set such that the lower ends of the first to fourth claw portions 61 to 64 correspond to the curvature of the surface of the photoreceptor drum Pk. It is preferable that the lengths of the first and fourth claw portions 61 and 64 in the vertical direction are longer than the lengths of the second and third claw portions 62 and 63 in the vertical direction, but the present invention is not limited thereto. The lengths of all the claw portions 61 to 64 in the vertical direction can also be set to be identical.

Further, in Example 1, all the positions of the first to fourth claw portions 61 to 64 in the front-rear direction are set to an identical position. That is, the first to fourth claw portions 61 to 64 are disposed at positions aligned in the longitudinal direction of the grid electrode 12. It is preferable that the positions of the first to fourth claw portions 61 to 64 in the front-rear direction are set to an identical position, but the present invention is not limited thereto. For example, the first and fourth claw portions 61 and 64 can be positioned outside the second and third claw portions 62 and 63 in the front-rear direction.

In FIG. 6, a positioning protruding portion 71 as an example of a portion to be positioned is formed on a lower surface of a rear end portion of the rear end block 3 serving as an example of a frame body of the charging device. The positioning protruding portion 71 is mounted in a state where the positioning protruding portion 71 penetrates the positioning opening 32 of the grid electrode 12.

A rear abutting portion 72 as an example of an abutting section is formed on a lower surface of the rear end block 3. Since the rear abutting portion 72 has a configuration identical to the configuration of the front abutting portion 41, the detailed description thereof will be omitted.

Further, a second rear abutting portion 74 as an example of a second abutting section is formed on a rear bearing portion 73 of the photoreceptor drum Pk. Since the second rear abutting portion 74 also has a configuration identical to the configuration of the second front abutting portion 43, the detailed description thereof will be omitted.

In FIGS. 5 and 6, the rear abutting portion 72 and the second rear abutting portion 74 are in contact with the net-like portion 13 of the grid electrode 12 from above and below. Although an aspect in which the rear abutting portion 72 and the second rear abutting portion 74 are in contact with the net-like portion 13 has been exemplified, the present invention is not limited thereto. For example, the rear frame portion 31 may extend in the longitudinal direction and the rear abutting portion 72 and the second rear abutting portion 74 may be in contact with the rear frame portion 31. In addition, the strength and stiffness of the net-like portion 13 are lower than the strength and stiffness of the rear frame portion 31. Therefore, even in a case where the rear frame portion 31 is curved, the curvature of the net-like portion 13 is likely to approach the shape of a flat plate. However, in a case where the net-like portion 13 is directly abutted to the rear abutting portion 72 and the second rear abutting portion 74, the curvature of the net-like portion 13 is expected to more approach the target shape.

An aspect in which the front abutting portion 41 and the second front abutting portion 43 are in contact with the hook portion 14 and the front frame portion 13c of the grid electrode 12 has been exemplified, but the present invention is not limited thereto. For example, an aspect in which both the front abutting portion 41 and the second front abutting portion 43 are in contact with the net-like portion 13 or are in contact with the hook portion 14 may also be provided.

The pulling member 51, the spring 57, the spring mounting portion 40, and the like constitute a tension applying section 58 of Example 1 that applies tension to the grid electrode 12. The spring constant of the spring 57 may also be changed to adjust the tension of the grid electrode 12. Further, since the tension of the grid electrode 12 is reduced in a case where the spring 57 is removed and the pulling member 51 is rotated about the through-hole portions 54, the grid electrode 12 can be removed or replaced.

### Action of Example 1

In the charger CCk of Example 1 having the above-described configuration, the hook portion 14 provided at the front end portion of the grid electrode 12 is mounted on the hook claw 60 in a state where the positioning opening 32 provided at the rear end is supported by the positioning protruding portion 71. In a case where the hook portion 14 is mounted on the hook claw 60, the hook portion 14 is pulled forward by a spring force of the spring 57. Therefore, tension acts on the grid electrode 12 in the front-rear direction.

The front abutting portion 41, the second front abutting portion 43, the rear abutting portion 72, and the second rear abutting portion 74 are in contact with the front and rear end portions of the grid electrode 12 of Example 1. Therefore, the grid electrode 12 is deformed along the surfaces of the front abutting portion 41 and the like in the lateral direction, and is held in a state where the grid electrode 12 is curved in a shape along the surface of the photoreceptor drum Pk.

Since the grid electrode 12 of the charger CCk is curved along the photoreceptor drum Pk, a distance between the photoreceptor drum Pk and the grid electrode 12 is made uniform from the upstream to the downstream in the rotation direction of the photoreceptor drum Pk. Accordingly, charging efficiency can be improved as compared to a case where the grid electrode 12 is not curved. Here, in a case where an abutting portion or the like curving the grid electrode 12 is provided in a middle portion of the grid electrode 12 in a longitudinal direction, charging is insufficient in the middle portion of the photoreceptor drum Pk in an axial direction. For this reason, a force for curving the grid electrode 12 needs to be applied to both end portions of the grid electrode 12 in the longitudinal direction. However, in a case where the grid electrode 12 is to be curved at both end portions of the grid electrode 12, the grid electrode 12 is likely to return to a flat state in the middle portion thereof in the longitudinal direction and the curved state is not maintained over the entire grid electrode 12 in the longitudinal direction. Therefore, a variation in charging capability may occur in the longitudinal direction of the charger CCk and cause a variation in the charged state of the photoreceptor drum Pk. In particular, in a case where the grid electrode 12 is in a curved state, the posture of the grid electrode 12 is likely to hold a straight state along the longitudinal direction in a state where tension acts. However, in a case where the grid electrode 12 is in a flat state, the grid electrode 12 is likely to sag due to the influence of gravity. Therefore, both end portions of the grid electrode 12 are disposed with a target interval from the photoreceptor drum Pk, but an interval between the grid electrode 12 and the photoreceptor drum Pk may be narrowed at the middle portion of the grid electrode 12 due to the sagging of the grid electrode 12.

Here, in the technique disclosed in JP2018-159793A ([0035] to [0087], FIGS. 2 to 6), two contact members (53, 54) are disposed to have positions shifted from each other in the longitudinal direction. In JP2018-159793A ([0035] to [0087], FIGS. 2 to 6), the two contact members (53, 54) deform an electrode member (40) into a target curved shape. Therefore, in JP2018-159793A ([0035] to [0087], FIGS. 2 to 6), the distribution of tension in the lateral direction is not considered, and the middle portion of the electrode member in the longitudinal direction may sag due to the lack of tension.

In JP2021-056456A ([0054] to [0099], FIGS. 4 to 7), two straight grid electrodes (53) are merely disposed to be inclined. Accordingly, a distance between the first grid electrode (53) and the photoreceptor drum (213) is not constant from upstream to downstream in the rotation direction of the photoreceptor drum (213), and a distance between the second grid electrode (53) and the photoreceptor drum (213) is also not constant. Therefore, a variation remains in charging capability.

Here, in Example 1, the second front abutting portion 43 and the second rear abutting portion 74 are formed to have heights that allow distal ends of the protruding portions 43a to further protrude from the curved line 43b on the middle side than on the end sides in the lateral direction. Therefore, tension acting on the grid electrode 12 is stronger on the middle side than on both sides in the lateral direction. That is, the tension is stronger on the inner side than on both sides of the curved grid electrode 12 in a circumferential direction.

### Experimental Examples

An experiment is performed to examine how the curvature of the grid electrode 12 varies in the axial direction depending on the distribution of the tension applied to the grid electrode 12 in the lateral direction.

The experiment is performed with regard to the distribution of the tension in the lateral direction using computer simulation in a case where the tension is identical at the middle portion and both end portions (flat), a case where the tension is stronger at the middle portion than at both the end portions (convex middle), and a case where the tension is weaker at the middle portion than at both the end portions (concave middle). Further, the experiment is performed in a case where the diameter of the photoreceptor drum is small and a case where the diameter of the photoreceptor drum is large.

Displacement corresponding to the abutting portions 41 and 72 is forcibly applied to both end portions of the grid electrode 12, and the degree of variation in each of a deviation between the curvature (ideal line) of the surface of the photoreceptor drum Pk and the curvature of both end portions of the grid electrode 12 in the longitudinal direction and a deviation between the ideal line and the curvature of the middle portion of the grid electrode 12 in the longitudinal direction is obtained in a case where tension corresponding to flat, convex middle, and concave middle is applied to both the end portions.

Results are shown in FIGS. 10 and 11.

FIG. 10 is a diagram illustrating an experimental example in a case where the diameter of the drum is small.

FIG. 11 is a diagram illustrating an experimental example in a case where the diameter of the drum is large.

In FIGS. 10 and 11, it is confirmed that a variation in the deviation in the axial direction in a case of “convex middle” is smaller than that in a case of “flat” or “concave middle”, and the variation is reduced as the tension is increased. Curvature along the ideal line (curved line 43b) is forcibly applied to both end portions of the grid electrode 12 in the longitudinal direction by the abutting portions 41 and 72, and the fact that the variation is small means that the middle portion of the grid electrode 12 in the longitudinal direction is also in a curved state close to the ideal line. Further, the fact that the variation is small in the case of “convex middle” means that the entire region of the grid electrode 12 in the longitudinal direction is in a curved state closer to the curvature of the photoreceptor drum Pk. A tendency identical to the above tendency is observed even in a case where the diameter of the drum is changed.

In the charger CCk of Example 1, tension is applied to the grid electrode 12 in the state of “convex middle”. Accordingly, a variation in the curvature of the grid electrode 12 in the longitudinal direction is suppressed as compared to a case where end portions of the grid electrode 12 in the longitudinal direction are made to abut against the second abutting portions 43 and 74 having a shape corresponding to the curvature of the photoreceptor drum Pk to curve the grid electrode 12 according to the curvature of the photoreceptor drum Pk.

In particular, in Example 1, the second abutting portions 43 and 74 are formed in a comb-tooth shape. Therefore, the second abutting portions 43 and 74 are not in contact with the entire surface of the grid electrode 12 in the lateral direction, but are intermittently in contact with the grid electrode 12. Since it is necessary to ensure the dimensional accuracy of the entire contact surface in the related art in which the abutting portions are in contact with the entire surface of the grid electrode, accuracy and cost are likely to be required for machining. In contrast, since the number of contact positions is small and it is easy to ensure the dimensional accuracy in Example 1 in which the second abutting portions 43 and 74 are intermittently in contact with the grid electrode 12, it is easy to set a tension distribution to a target distribution.

### Example 2

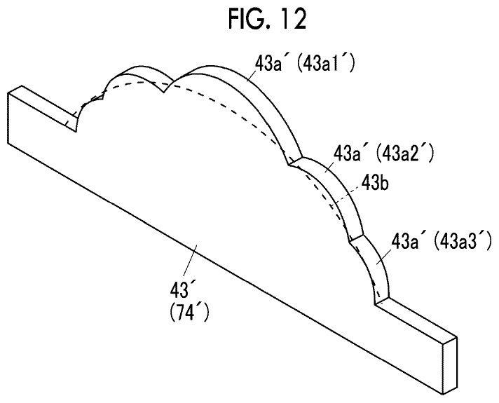

FIG. 12 is a diagram illustrating an abutting section of Example 2, and is a diagram corresponding to FIG. 9 of Example 1.

In the description of Example 2, components corresponding to the components of Example 1 will be denoted by identical reference numerals and detailed description thereof will be omitted.

Example 2 is different from Example 1 in terms of the following points, but has a configuration identical to the configuration of Example 1 in terms of other points.

In FIG. 12, each of second abutting portions 43′ and 74′ of Example 2 includes a plurality of protruding portions 43a′ that have curvatures and are arranged along the lateral direction of the grid electrode 12, instead of having the comb-tooth shape of Example 1. In Example 2, with regard to the curvatures of the respective protruding portions 43a1′ to 43a3′, the curvature of the protruding portion provided on the middle side in the lateral direction is larger than the curvatures of the protruding portions provided on the end sides in the lateral direction.

The protruding portion 43a1′ provided on the middle side in the lateral direction further protrudes from the curved line 43b than the protruding portions 43a3′ provided on the end sides. In addition, a portion that does not protrude from the curved line 43b is present between the protruding portions 43a1′ to 43a3′ having the curvatures.

Accordingly, even in a charger CCk of Example 2, tension is applied to the grid electrode 12 in the state of “convex middle”. Therefore, a variation in the longitudinal direction in the curvature of the grid electrode 12 is suppressed as compared to a case where a force for pulling the grid electrode 12 is uniform (flat) in the lateral direction of the grid electrode 12 or the case of “concave middle”.

### Modification Examples

Example of the present invention has been described in detail above. However, the present invention is not limited to Example described above, and can have various modifications without departing from the scope of the present invention described in claims. Modification Examples (H01) to (H06) of the present invention will be exemplified below.
(H01) In Example described above, the present invention is not limited to the copying machine as an example of the image forming apparatus and can also be applied to image forming apparatuses, such as a printer and a FAX. Further, the present invention is not limited to the color image forming apparatus and can also be applied to a monochrome image forming apparatus. Furthermore, the present invention is not limited to the tandem type image forming apparatus, and can also be applied to a rotary type image forming apparatus.
(H02) A case where the wire electrode 11 is one wire rod has been exemplified in Examples described above. However, the present invention is not limited thereto, and a configuration in which the wire electrode 11 includes two or more wire rods or the like can also be adopted.
(H03) A configuration in which the shield electrode 2 is not provided can also be adopted in Example described above.
(H04) The scorotron type charger has been exemplified in Example described above, but the present invention is not limited thereto. For example, other discharge type chargers can also be used as a static eliminator or an auxiliary charger for the photoreceptor drums Py to Pk or the recording sheet S, the transfer modules T1y to T1k and T2, and the like.
(H05) The net-like grid electrode 12 has been exemplified as an example of the control electrode in Examples described above, but the present invention is not limited thereto. For example, the present invention can also be applied to a control electrode in a form (vertical stripe shape) in which a plurality of wires extend in a longitudinal direction.
(H06) An aspect in which the second abutting portions 43, 43′, 74, and 74′ are disposed on the photoreceptor drum Pk side has been described in Examples described above, but the present invention is not limited thereto. For example, an aspect in which the grid electrode 12 is supported by the front end block 4 and the rear end block 3 of the charger CCK via brackets, arms, or the like may also be adopted.

### SUPPLEMENTARY NOTE

(((1)))

A charging device comprising:
a discharge electrode; and
a control electrode that is disposed between the discharge electrode and a member to be charged,
wherein the control electrode is held in a state of being curved along a surface shape of the member to be charged, is pushed to a side away from the member to be charged at a plurality of positions along a lateral direction of the control electrode, and further protrudes toward the side away from the member to be charged on a middle side than on end sides in the lateral direction among the plurality of positions where the control electrode is pushed.
(((2)))

A charging device comprising:
a discharge electrode; and
a control electrode that is disposed between the discharge electrode and a member to be charged,
wherein the control electrode is held in a state of being curved along a surface shape of the member to be charged, at least one portion where the control electrode is not pushed to a side away from the member to be charged is present along a lateral direction of the control electrode, and the control electrode further protrudes toward the side away from the member to be charged on a middle side than on end sides in the lateral direction among a plurality of positions where the control electrode is pushed.
(((3)))

A charging device comprising:
a discharge electrode; and
a control electrode that is disposed between the discharge electrode and a member to be charged and draws out electric charges from the discharge electrode toward the member to be charged,
wherein the control electrode is held in a state of being curved along a surface shape of the member to be charged and is pushed to a side away from the member to be charged at a plurality of positions along a lateral direction of the control electrode, and a pushing force is stronger on a middle side than on end sides in the lateral direction among the plurality of positions where the control electrode is pushed.
(((4)))

The charging device according to any one of (((1))) to (((3))), further comprising:
a curving section that is supported by a frame body of the charging device and pushes the control electrode to the side away from the member to be charged to curve the control electrode,
wherein the curving section includes a plurality of contact portions that extend in a direction away from the member to be charged and are arranged along the lateral direction of the control electrode, and lengths of the contact portions provided on the middle side in the lateral direction are longer than lengths of the contact portions provided on the end sides in the lateral direction with respect to the surface shape of the member to be charged.
(((5)))

The charging device according to any one of (((1))) to (((3))), further comprising:
a curving section that is supported by a frame body of the charging device and pushes the control electrode to the side away from the member to be charged to curve the control electrode,
wherein the curving section includes a plurality of contact portions that have curvatures and are arranged along the lateral direction of the control electrode, and the curvatures of the contact portions provided on the middle side in the lateral direction are larger than the curvatures of the contact portions provided on the end sides in the lateral direction.
(((6)))

The charging device according to (((4))) or (((5))),
wherein the control electrode includes a frame portion that is disposed along an outer periphery of the control electrode and a net portion that is disposed inside the frame portion, and
the curving section is in contact with the frame portion.
(((7)))

An image forming apparatus comprising:
a member to be charged that is formed of an image holding section;
a charging device according to any one of (((1))) to (((6))) that charges the image holding section;
a latent image forming section that forms a latent image on the image holding section;
a developing section that develops the latent image formed on the image holding section;
a transfer section that transfers an image developed by the developing section onto a medium; and
a fixing section that fixes the image to the medium.
(((8)))

The image forming apparatus according to (((7))), further comprising:
a curving section that is provided on the member to be charged and pushes the control electrode to the side away from the member to be charged to curve the control electrode,
wherein the curving section includes a plurality of contact portions that extend in a direction away from the member to be charged and are arranged along the lateral direction of the control electrode, and lengths of the contact portions provided on the middle side in the lateral direction are longer than lengths of the contact portions provided on the end sides in the lateral direction with respect to the surface shape of the member to be charged.
(((9)))

The image forming apparatus according to (((7))), further comprising:
a curving section that is provided on the member to be charged and pushes the control electrode to the side away from the member to be charged to curve the control electrode,
wherein the curving section includes a plurality of contact portions that have curvatures and are arranged along the lateral direction of the control electrode, and the curvatures of the contact portions provided on the middle side in the lateral direction are larger than the curvatures of the contact portions provided on the end sides in the lateral direction.
(((10)))

The image forming apparatus according to (((8))) or (((9))),
wherein the control electrode includes a frame portion that is disposed along an outer periphery of the control electrode and a net portion that is disposed inside the frame portion, and
the curving section is in contact with the frame portion.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A charging device comprising:
a discharge electrode; and
a control electrode that is disposed between the discharge electrode and a member to be charged,
wherein the control electrode is held in a state of being curved along a surface shape of the member to be charged, is pushed to a side away from the member to be charged at a plurality of positions along a lateral direction of the control electrode, and further protrudes toward the side away from the member to be charged on a middle side than on end sides in the lateral direction among the plurality of positions where the control electrode is pushed.

2. A charging device comprising:
a discharge electrode; and
a control electrode that is disposed between the discharge electrode and a member to be charged,
wherein the control electrode is held in a state of being curved along a surface shape of the member to be charged, at least one portion where the control electrode is not pushed to a side away from the member to be charged is present along a lateral direction of the control electrode, and the control electrode further protrudes toward the side away from the member to be charged on a middle side than on end sides in the lateral direction among a plurality of positions where the control electrode is pushed.

3. A charging device comprising:
a discharge electrode; and
a control electrode that is disposed between the discharge electrode and a member to be charged and draws out electric charges from the discharge electrode toward the member to be charged,
wherein the control electrode is held in a state of being curved along a surface shape of the member to be charged and is pushed to a side away from the member to be charged at a plurality of positions along a lateral direction of the control electrode, and a pushing force is stronger on a middle side than on end sides in the lateral direction among the plurality of positions where the control electrode is pushed.

4. The charging device according to claim 1, further comprising:
a curving section that is supported by a frame body of the charging device and pushes the control electrode to the side away from the member to be charged to curve the control electrode,
wherein the curving section includes a plurality of contact portions that extend in a direction away from the member to be charged and are arranged along the lateral direction of the control electrode, and lengths of the contact portions provided on the middle side in the lateral direction are longer than lengths of the contact portions provided on the end sides in the lateral direction with respect to the surface shape of the member to be charged.

5. The charging device according to claim 2, further comprising:
a curving section that is supported by a frame body of the charging device and pushes the control electrode to the side away from the member to be charged to curve the control electrode,
wherein the curving section includes a plurality of contact portions that extend in a direction away from the member to be charged and are arranged along the lateral direction of the control electrode, and lengths of the contact portions provided on the middle side in the lateral direction are longer than lengths of the contact portions provided on the end sides in the lateral direction with respect to the surface shape of the member to be charged.

6. The charging device according to claim 3, further comprising:
a curving section that is supported by a frame body of the charging device and pushes the control electrode to the side away from the member to be charged to curve the control electrode,
wherein the curving section includes a plurality of contact portions that extend in a direction away from the member to be charged and are arranged along the lateral direction of the control electrode, and lengths of the contact portions provided on the middle side in the lateral direction are longer than lengths of the contact portions provided on the end sides in the lateral direction with respect to the surface shape of the member to be charged.

7. The charging device according to claim 1, further comprising:
a curving section that is supported by a frame body of the charging device and pushes the control electrode to the side away from the member to be charged to curve the control electrode,
wherein the curving section includes a plurality of contact portions that have curvatures and are arranged along the lateral direction of the control electrode, and the curvatures of the contact portions provided on the middle side in the lateral direction are larger than the curvatures of the contact portions provided on the end sides in the lateral direction.

8. The charging device according to claim 2, further comprising:
a curving section that is supported by a frame body of the charging device and pushes the control electrode to the side away from the member to be charged to curve the control electrode,
wherein the curving section includes a plurality of contact portions that have curvatures and are arranged along the lateral direction of the control electrode, and the curvatures of the contact portions provided on the middle side in the lateral direction are larger than the curvatures of the contact portions provided on the end sides in the lateral direction.

9. The charging device according to claim 3, further comprising:
a curving section that is supported by a frame body of the charging device and pushes the control electrode to the side away from the member to be charged to curve the control electrode,
wherein the curving section includes a plurality of contact portions that have curvatures and are arranged along the lateral direction of the control electrode, and the curvatures of the contact portions provided on the middle side in the lateral direction are larger than the curvatures of the contact portions provided on the end sides in the lateral direction.

10. The charging device according to claim 4,
wherein the control electrode includes a frame portion that is disposed along an outer periphery of the control electrode and a net portion that is disposed inside the frame portion, and
the curving section is in contact with the frame portion.

11. The charging device according to claim 5,
wherein the control electrode includes a frame portion that is disposed along an outer periphery of the control electrode and a net portion that is disposed inside the frame portion, and
the curving section is in contact with the frame portion.

12. The charging device according to claim 6,
wherein the control electrode includes a frame portion that is disposed along an outer periphery of the control electrode and a net portion that is disposed inside the frame portion, and
the curving section is in contact with the frame portion.

13. An image forming apparatus comprising:
a member to be charged that is formed of an image holding section;
a charging device according to claim 1 that charges the image holding section;
a latent image forming section that forms a latent image on the image holding section;
a developing section that develops the latent image formed on the image holding section;
a transfer section that transfers an image developed by the developing section onto a medium; and
a fixing section that fixes the image to the medium.

14. An image forming apparatus comprising:
a member to be charged that is formed of an image holding section;
a charging device according to claim 2 that charges the image holding section;
a latent image forming section that forms a latent image on the image holding section;
a developing section that develops the latent image formed on the image holding section;
a transfer section that transfers an image developed by the developing section onto a medium; and
a fixing section that fixes the image to the medium.

15. An image forming apparatus comprising:
a member to be charged that is formed of an image holding section;
a charging device according to claim 3 that charges the image holding section;
a latent image forming section that forms a latent image on the image holding section;
a developing section that develops the latent image formed on the image holding section;
a transfer section that transfers an image developed by the developing section onto a medium; and
a fixing section that fixes the image to the medium.

16. The image forming apparatus according to claim 13, further comprising:
a curving section that is provided on the member to be charged and pushes the control electrode to the side away from the member to be charged to curve the control electrode,
wherein the curving section includes a plurality of contact portions that extend in a direction away from the member to be charged and are arranged along the lateral direction of the control electrode, and lengths of the contact portions provided on the middle side in the lateral direction are longer than lengths of the contact portions provided on the end sides in the lateral direction with respect to the surface shape of the member to be charged.

17. The image forming apparatus according to claim 14, further comprising:
a curving section that is provided on the member to be charged and pushes the control electrode to the side away from the member to be charged to curve the control electrode,
wherein the curving section includes a plurality of contact portions that extend in a direction away from the member to be charged and are arranged along the lateral direction of the control electrode, and lengths of the contact portions provided on the middle side in the lateral direction are longer than lengths of the contact portions provided on the end sides in the lateral direction with respect to the surface shape of the member to be charged.

18. The image forming apparatus according to claim 15, further comprising:
a curving section that is provided on the member to be charged and pushes the control electrode to the side away from the member to be charged to curve the control electrode,
wherein the curving section includes a plurality of contact portions that extend in a direction away from the member to be charged and are arranged along the lateral direction of the control electrode, and lengths of the contact portions provided on the middle side in the lateral direction are longer than lengths of the contact portions provided on the end sides in the lateral direction with respect to the surface shape of the member to be charged.

19. The image forming apparatus according to claim 13, further comprising:
a curving section that is provided on the member to be charged and pushes the control electrode to the side away from the member to be charged to curve the control electrode,
wherein the curving section includes a plurality of contact portions that have curvatures and are arranged along the lateral direction of the control electrode, and the curvatures of the contact portions provided on the middle side in the lateral direction are larger than the curvatures of the contact portions provided on the end sides in the lateral direction.

20. The image forming apparatus according to claim 16,
wherein the control electrode includes a frame portion that is disposed along an outer periphery of the control electrode and a net portion that is disposed inside the frame portion, and
the curving section is in contact with the frame portion.
